(19) United States
(12) Patent Application Publication
(10) Pub. No.: US 2011/0135421 A1
(43) Pub. Date: Jun. 9, 2011

(54) METAL PLATE MEMBER FIXATION DEVICE

(76) Inventor: Ming-Chung CHIU, Keelung City (TW)

(21) Appl. No.: 12/634,371

(22) Filed: Dec. 9, 2009

(51) Int. Cl. F16B 39/30

(52) U.S. Cl. 411/167

(57) ABSTRACT

A metal plate member fixation device includes an adapter having a hollow base and a tubular bonding portion perpendicularly extended from the hollow base for bonding to a mounting through hole of a first metal plate member, and a locking device formed of a barrel, which is detachably connectable to the hollow base of the adapter before bonding of the adapter to the first metal plate member, a driving member, a lock screw and a spring member and adapted for detachably locking the first metal plate member to a second metal plate member.

### BACKGROUND OF THE INVENTION

1. Field of the Invention

The present invention relates to a metal plate member fixation device for joining two metal plate members and more particularly, to such a metal plate member fixation device, which uses an adapter for bonding to a first metal plate member for enabling a locking device to be detachably coupled to the adapter to lock the first metal plate member to a second metal plate member.

2. Description of the Related Art

When fastening plate members together, a positioning screw formed of a knob, a ring and a screw nail may be used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together.

The power drive and speed-adjustment unit of a machine tool are generally provided inside the housing. To facilitate repair of a machine tool or adjustment of the output speed of a machine tool, a detachable plate member is usually provided at the housing of the power drive or speed-adjustment unit. When the power drive or speed-adjustment unit fails or is damaged, the detachable plate member removed from the housing, facilitating the repair or adjustment work. According to conventional techniques, screw bolts are commonly used to fasten the movable plate member to the housing. When unfastening the screw bolts to dismount the movable plate member from the housing, the associating lock nuts may fall from the screw bolts and fallen lock nuts may be lost. When this problem happens, reinstallation of the movable plate member becomes difficult. Further, this movable plate member mounting and dismounting procedure is complicated, wasting much time and labor.

FIGS. 8 and 9 illustrate a prior art metal plate member fixation device A for joining two metal plate members together, which is comprised of a cap A1, a screw bolt A2 and a barrel A3. The cap A1 is affixed to the head of the screw bolt A2. During installation, the mounting portion A31 of the barrel A3 is fixedly fastened to a mounting through hole B1 of a first plate member B, and then the screw bolt A2 is inserted through the barrel A3 and threaded into a second plate member C to lock the two plate members B and C together. When loosened the screw bolt A2 from the second plate member C, the first plate member B can be removed from the second plate member C. After removable of the first plate member B from the second plate member C, the metal plate member fixation device A is kept secured to the first plate member B. According to this design, the cap A1, the screw bolt A2 and the barrel A3 must be assembled before fixation of the barrel A3 to the first plate member B by reflow soldering. In actual practice, this design of plate member fixation device A has drawbacks as follows:
1. When affixing the barrel A3 to the first plate member B by reflow soldering, molten solder paste may flow into the inside of the mounting portion A31 of the barrel A3 and bonded to the screw bolt A2. When this solder paste overflow problem happens, the screw bolt A2 may be not rotatable relative to the barrel A3 smoothly, resulting in installation difficulty.
2. The cap A1, the screw bolt A2 and the barrel A3 are specifically designed to fit one another, other similar components cannot be used as substitutes for the parts of the metal plate member fixation device A.
3. The first plate member B must be processed to provide a particular size of mounting through hole B1 for the mounting of the barrel A3 of the plate member fixation device A, i.e., the plate member fixation device A is not applicable to any plate member without a mounting through hole that fits the mounting portion A31 of the barrel A3.

Therefore, it is desirable to provide a metal plate member fixation device that eliminates the aforesaid problems.

### SUMMARY OF THE INVENTION

The present invention has been accomplished under the circumstances in view. According to one aspect of the present invention, a metal plate member fixation device includes an adapter for bonding to a first metal plate member, and a locking device detachably connectable to the adapter for locking the first metal plate member to a second metal plate member. The locking device comprises a barrel detachably connectable to the adapter, a lock screw axially movably inserted through the barrel, a driving member fixedly connected to one end of the lock screw and disposed outside the barrel, and a spring member sleeved onto the lock screw and stopped between a part of the barrel and a part of the lock screw.

Further, the adapter can be bonded to a metal plate member before connection of the barrel of the locking device to the adapter. Therefore, bonding the adapter to the metal plate member by a soldering technique does not affect normal functioning of the locking device or cause any damage to the locking device.

Because the locking device is detachably connected to the first metal plate member by means of the adapter, the component parts of the locking device are not constraint to specific specifications, i.e., the adapter fits different models and sizes of locking devices.

### BRIEF DESCRIPTION OF THE DRAWINGS

FIG. 1 is an elevational view showing a metal plate member fixation device mounted in a metal plate member according to a first embodiment of the present invention.

FIG. 2 is an exploded view of the metal plate member fixation device according to the first embodiment of the present invention.

FIG. 3 is a schematic sectional view of the first embodiment of the present invention, showing the metal plate member fixation device installed in one metal plate member before fixation to a second metal plate member.

FIG. 4 is another exploded view of the metal plate member fixation device according to the first embodiment of the present invention.

FIG. 5 corresponds to FIG. 4 when viewed from another angle.

FIG. 6 is a sectional installed view of a metal plate member fixation device according to a second embodiment of the present invention (I).

FIG. 7 is a sectional installed view of a metal plate member fixation device according to a second embodiment of the present invention (II).

FIG. 8 is an exploded side view in section of a metal plate member fixation device according to the prior art.

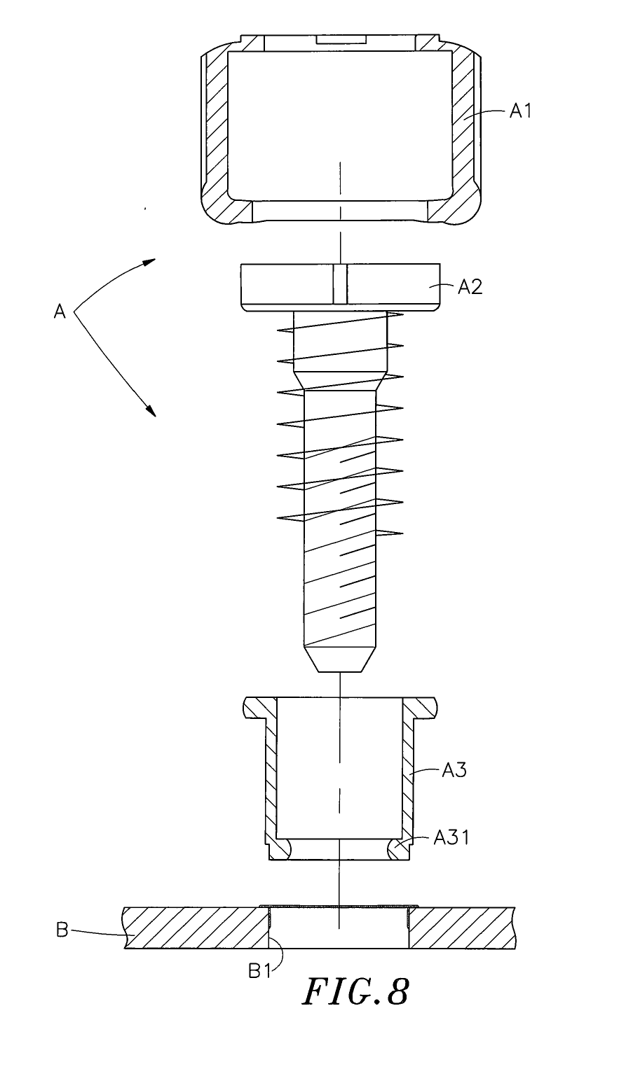

FIG. 9 is a sectional side view of the metal plate member fixation device according to the prior art.

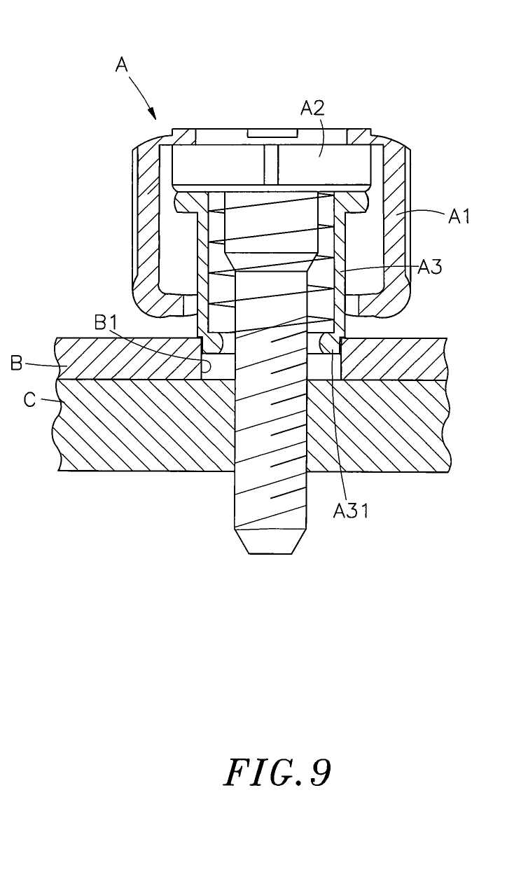

### DETAILED DESCRIPTION OF THE PREFERRED EMBODIMENT

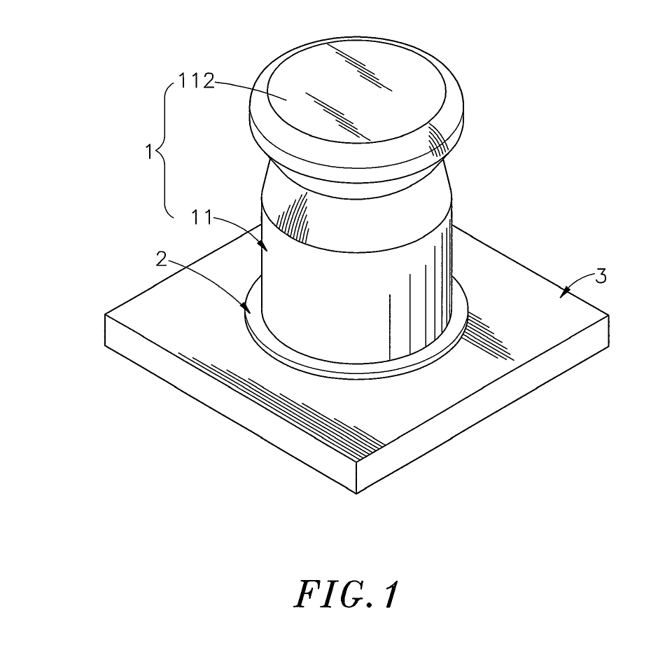

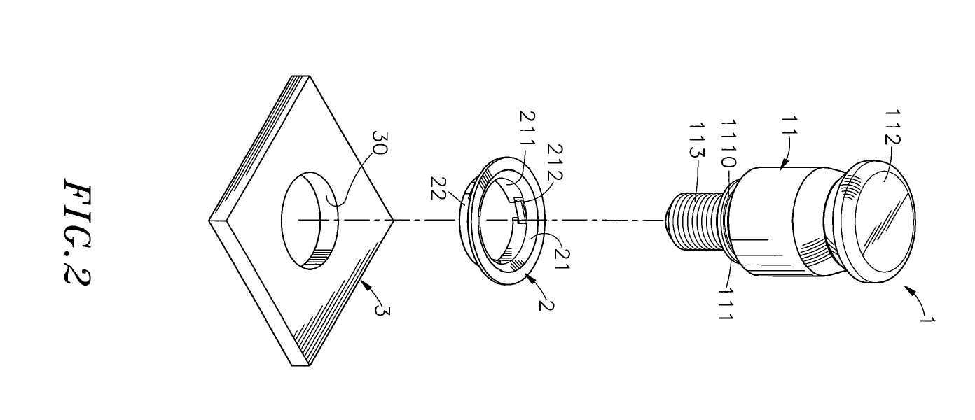

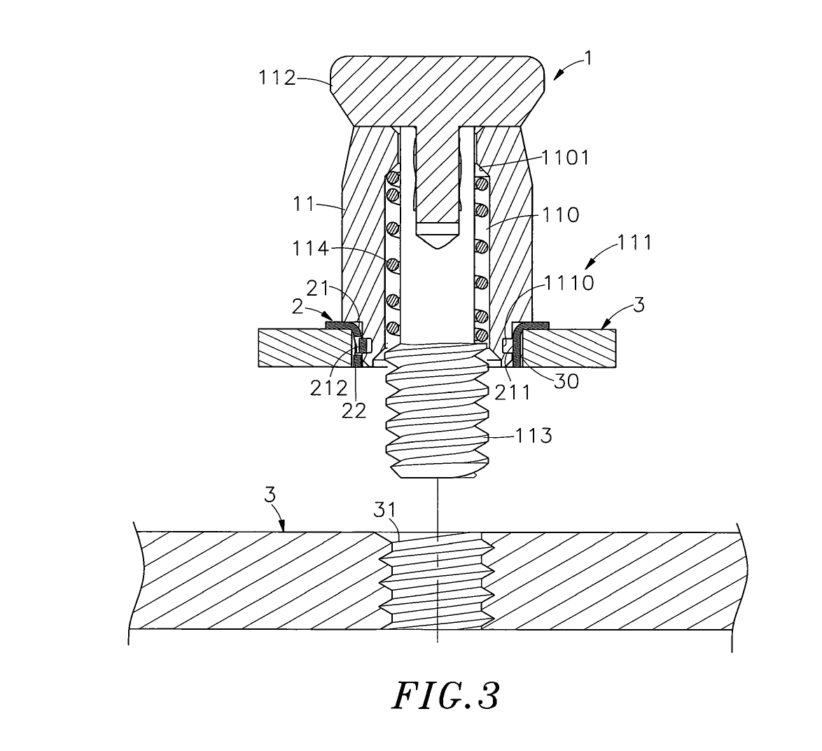

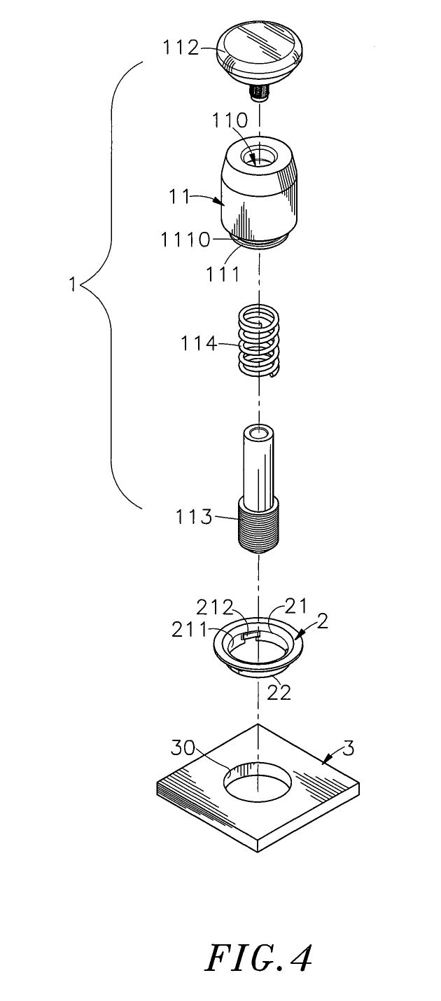

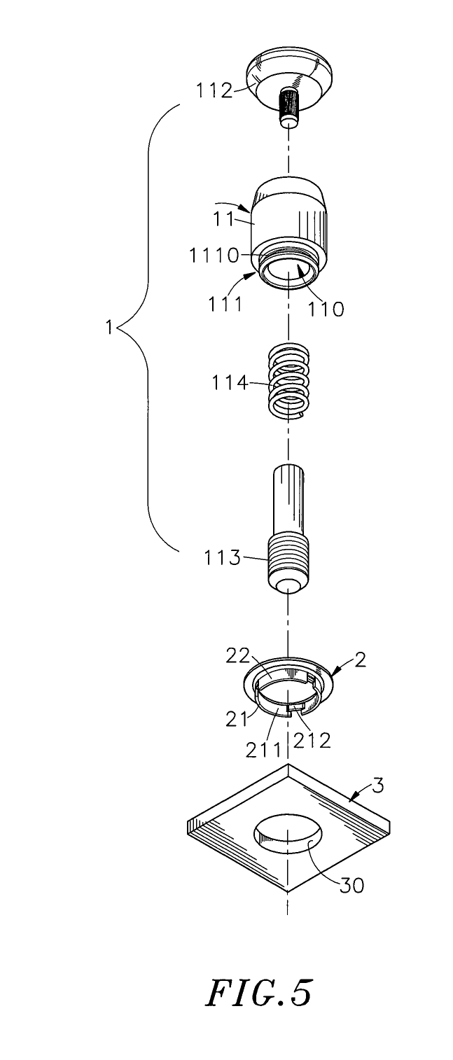

Referring to FIGS. 1-5, a metal plate member fixation device in accordance with a first embodiment of the present invention is shown comprising a locking device 1 and an adapter 2.

The locking device 1 comprises a barrel 11, a driving member 112, a lock screw 113 and a spring member 114. The barrel 11 has a mounting hole 110 longitudinally extending through top and bottom sides thereof, a shoulder 1101 formed in the mounting hole 110 near the top side, a bottom extension tube 111 perpendicularly downwardly extended from the bottom side around the mounting hole 110 and an outside annular groove 1110 extending around the periphery of the bottom extension tube 111. The driving member 112 is arranged at the top side of the barrel 11. The lock screw 113 is inserted into the mounting hole 110 and connected to the driving member 112 and partially extending out of the bottom extension tube 111. The spring member 114 is sleeved onto the lock screw 113 and stopped between the shoulder 1101 and a part of the lock screw 113 to impart a pressure to the lock screw 113, forcing the lock screw 113 out of the bottom extension tube 111. Subject to the effect of the spring member 114, the lock screw 113 is axially movable relative to the barrel 11 within a limited distance.

The adapter 2 is a hollow circular member, having a hollow base 21, a plurality of springy retaining portions 212 protruded from the annular inside wall 211 of the annular base 21 and a tubular bonding portion 22 perpendicularly extended from the annular inside wall 211 of the hollow base 21.

During installation, the tubular bonding portion 22 of the adapter 2 is inserted into a mounting through hole 30 of one metal plate member 3 and bonded thereto by a soldering technique. Thereafter, insert the bottom extension tube 111 of the barrel 11 into the hollow base 21 to force the outside annular groove 1110 of the barrel 11 into engagement with the springy retaining portions 212 of the adapter 2. Thus, the metal plate member fixation device is secured to the metal plate member 3. At this time, the user can rotate the driving member 112 to drive the lock screw 113 into the mounting screw hole 31 of another metal plate member 3 to lock the two metal plate members 3 together.

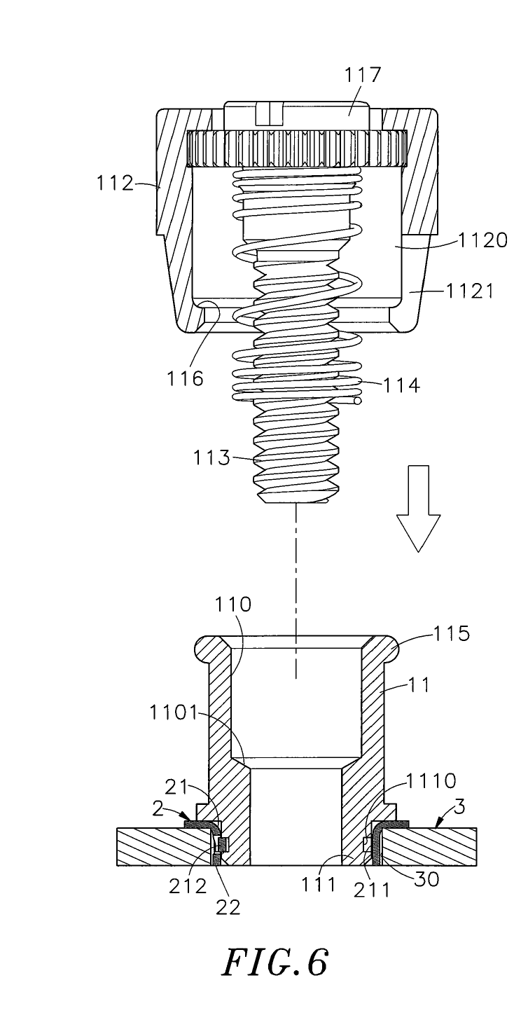

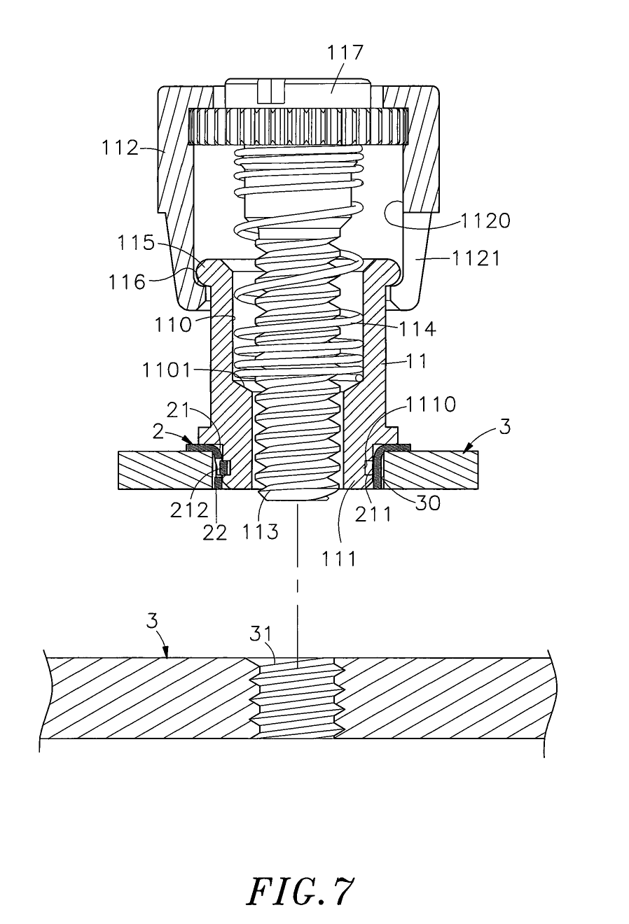

Referring to FIGS. 6 and 7, a metal plate member fixation device in accordance with a second embodiment of the present invention is shown comprising a locking device formed of a barrel 11, a driving member 112, a lock screw 113 and a spring member 114. The barrel 11 has a mounting hole 110 longitudinally extending through top and bottom sides thereof, a top flange 115 extending around the periphery at the top side, a shoulder 1101 formed in the mounting hole 110 on the middle, a bottom extension tube 111 perpendicularly downwardly extended from the bottom side around the mounting hole 110 and an outside annular groove 1110 extending around the periphery of the bottom extension tube 111. The driving member 112 is a hollow member, having a center opening 1120, a plurality of longitudinal crevices 1121 cut through the periphery and a bottom coupling flange 116 coupled to the top flange 115 of the barrel 11 for allowing axial movement of the lock screw 113 with the driving member 112 relative to the barrel 11 and a tool groove 117 located on the top wall for receiving a hand tool (flat-tip screwdriver, crossed-tip screwdriver, hex wrench, hex socket wrench, open-ended spanner, pliers or the like) to be used to rotate the driving member 112 relative to the barrel 11. The lock screw 113 is fixedly fastened to the driving member 112 and axially extending out of the center opening 1120. The spring member 114 is sleeved onto the lock screw 113 and stopped between the shoulder 1101 of the barrel 11 and the head of the lock screw 113. The adapter 2 according to this second embodiment is same as that of the aforesaid first embodiment.

Before connection the driving member 112 to the barrel 11, the tubular bonding portion 22 of the adapter 2 is inserted into the mounting through hole 30 of one metal plate member 3 and bonded thereto by a soldering technique, and then the bottom extension tube 111 of the barrel 11 is inserted into the hollow base 21 of the adapter 2 to force the outside annular groove 1110 of the barrel 11 into engagement with the springy retaining portions 212 of the adapter 2. Thereafter, insert the lock screw 113 into the barrel 11, and then couple the bottom coupling flange 116 of the driving member 112 to the top flange 115 of the barrel 11 to have the spring member 114 be stopped between the shoulder 1101 of the barrel 11 and the head of the lock screw 113, thus, the metal plate member fixation device is secured to the metal plate member 3. By means of the longitudinal crevices 1121, the bottom coupling flange 116 of the driving member 112 can be coupled to the top flange 115 of the barrel 11 conveniently. Thereafter, the user can rotate the driving member 112 to drive the lock screw 113 into the mounting screw hole 31 of another metal plate member 3 to lock the two metal plate members 3 together.

Further, in either of the aforesaid two embodiments, a screw joint can be employed for allowing detachable connection between the bottom extension tube 111 of the barrel 1 and the hollow base 21 of the adapter 2.

Further, the adapter 2 is made in one single model and size to fit different locking devices (the locking device according to the aforesaid first embodiment and the locking device according to the aforesaid second embodiment). Therefore, the metal plate member 3 needs to be processed to provide one same size of mounting through holes 30 only, facilitating selective installation of different models of metal plate member fixation devices.

As stated above, the invention provides a metal plate member fixation device comprised of a locking device 1 and an adapter 2. By means of the tubular bonding portion 22, the adapter 2 can be conveniently bonded to the mounting through hole 30 of one metal plate member 3 so that the user can insert the bottom extension tube 111 of the barrel 11 into the hollow base 21 of the adapter 2 to force the outside annular groove 1110 of the barrel 11 into engagement with the springy retaining portions 212 of the adapter 2 after bonding of the adapter 2 to the mounting through hole 30 of one metal plate member 3 and installation of the driving member 112, the lock screw 113 and the spring member 114 in the barrel 11.

In actual practice, the metal plate member fixation device of the present invention has the following advantages and features:
1. The adapter 2 can be bonded to a metal plate member 3 before connection of the barrel 11 of the locking device 1 to the adapter 2. Therefore, bonding the adapter 2 to the metal plate member 3 by a soldering technique does not affect normal functioning of the locking device 1 or cause any damage to the locking device 1.
2. After installation of the adapter 2 in the metal plate member 3, the barrel 11 can be conveniently detachably fastened to the adapter 2 by means of inserting the bottom extension tube 111 of the barrel 11 into the hollow base 21 of the adapter 2 to force the outside annular groove 1110 of the barrel 11 into engagement with the springy retaining portions 212 of the adapter 2.
3. The locking device 1 is detachably connected to the mounting through hole 30 of the metal plate member 3 by means of the adapter 2, therefore the processing of the mounting through hole 30 of the metal plate member 3 is easy and determined subject to the size of the adapter 2 without considering the specifications of the component parts of the locking device 1. Therefore, the invention facilitates mass production of the metal plate member 3.

A prototype of metal plate member fixation device has been constructed with the features of FIGS. 1-7. The metal plate member fixation device functions smoothly to provide all of the features disclosed earlier.

Although particular embodiments of the invention have been described in detail for purposes of illustration, various modifications and enhancements may be made without departing from the spirit and scope of the invention. For example, any of a variety of known detachable connection techniques may be employed to substitute for the connection arrangement between the outside annular groove of the bottom extension tube of the barrel and the springy retaining portions of the hollow base of the adapter (or screw joint between the bottom extension tube of the barrel and the hollow base of the adapter). Accordingly, the invention is not to be limited except as by the appended claims.

What the invention claimed is:

1. A metal plate member fixation device, comprising:
an adapter, said adapter comprising a hollow base having an annular inside wall and a tubular bonding portion perpendicularly extended from said annular inside wall of said hollow base for bonding to a mounting through hole of a first metal plate member; and
a locking device detachably connectable to said hollow base of said adapter for locking the first metal plate member to which said adapter is bonded to a second metal plate member, said locking device comprising a barrel detachably connectable to said hollow base of said adapter, said barrel comprising a bottom extension tube detachably connectable to said annular inside wall of said follow base of said adapter.

2. The metal plate member fixation device as claimed in claim 1, wherein said locking device further comprises a lock screw inserted through said barrel, a driving member fixedly connected to one end of said lock screw and disposed at one side outside said barrel remote from said bottom extension tube, and a spring member sleeved onto said lock screw and stopped between a part of said barrel and a part of said lock screw.

3. The metal plate member fixation device as claimed in claim 2, wherein said barrel comprises a top coupling flange extending around the periphery of a top side thereof remote from said bottom extension tube; said driving member comprises a center opening for accommodating said lock screw and said spring member, a bottom coupling flange coupled to said top flange of said barrel for allowing axial movement of said driving member relative to said barrel and a tool groove located on a top wall thereof for receiving a hand tool (flat-tip screwdriver, crossed-tip screwdriver.

4. The metal plate member fixation device as claimed in claim 2, wherein said adapter further comprises at least one springy retaining portion protruded from said annular inside wall of said hollow base; said barrel further comprises an annular groove extending around the periphery of said bottom extension tube for engagement with said at least one springy retaining portion of said adapter.
